(19) United States
(12) Patent Application Publication
(10) Pub. No.: US 2016/0209259 A1
(43) Pub. Date: Jul. 21, 2016

(54) MEASUREMENT DEVICE, MEASUREMENT SYSTEM, CANISTER AND MEASUREMENT METHOD

(71) Applicant: George EDWARDS, Hartfield East Sussex (GB)

(72) Inventor: George Edwards, Hartfield, East Sussex (GB)

(21) Appl. No.: 14/912,825

(22) PCT Filed: Aug. 21, 2014
(86) PCT No.: PCT/GB2014/052570

§ 371 Date: Feb. 18, 2016

(30) Foreign Application Priority Data
Aug. 21, 2013 (GB) 1314928.1

(51) Int. Cl. G01F 23/24

(52) U.S. Cl. CPC G01F 23/246

(57) ABSTRACT

measurement device for monitoring the level of liquefied gas in a canister is described. The device comprises an array of at least three temperature sensors, configured to be mounted externally of the canister to extend from a first position on the canister to a second position on the canister. The device also comprises detection circuitry for detecting, when gas is released from the canister causing a temperature drop at the liquid-gas interface within the canister, a subset of the temperature sensors measuring a lower temperature than the remainder of the temperature sensors, and for identifying a current level of the liquefied gas in the canister based on the position within the array of the subset of the temperature sensors detected as measuring a lower temperature. This arrangement can be retrofitted to any canister, without the need to modify the canister or change the valve arrangement.

### FIELD OF THE INVENTION

The present invention relates to a measurement device, a measurement system, a canister and a measurement method for measuring the level of liquefied gas in a canister.

### BACKGROUND TO THE INVENTION

Liquefied gas canisters are widely used for providing a stationary or portable supply of gas for domestic or commercial use. Liquefied Petroleum Gas (LPG) is one example of a gas which is commonly stored, in liquid form under pressure, in such canisters. One difficulty with liquefied gas canisters is determining the current level of liquefied gas in the canister. The bodies of these canisters are typically opaque, so that no visual indication is available. Current techniques for determining the amount of liquefied gas remaining include weighing the canister, acoustic sampling methods, a float provided within the canister, or special valves which measure the pressure in the container. Each of these techniques suffers from various disadvantages.

### SUMMARY OF THE INVENTION

According to an aspect of the invention, there is provided a measurement device for monitoring the level of liquefied gas in a canister, the device comprising:

an array of at least three temperature sensors, configured to be mounted externally of the canister to extend from a first position on the canister to a second position on the canister; and

detection circuitry for detecting, when gas is released from the canister causing a temperature drop at the liquid-gas interface within the canister, a subset of the temperature sensors which measure a lower temperature than the remainder of the temperature sensors, and for identifying a current level of the liquefied gas in the canister based on the position within the array of the subset of the temperature sensors detected as measuring a lower temperature.

The array of temperature sensors may be substantially linear, or at least provided on a substrate (e.g. strip) which extends substantially linearly from the first position to the second position. This arrangement can be provided relatively cheaply, since the main components are likely to be a set of thermistors, mounted for example on a strip, and some simple electronics able to process the outputs of the thermistors to determine which thermistors are reading a lower temperature than others of the thermistors. This arrangement can be retrofitted to any canister, without the need to modify the canister or change the valve arrangement. The first position may be at or near the bottom of the canister, and the second position may be at or near the top of the canister. However, it will be appreciated that, in some cases, the user may only be interested in the liquefied gas level in the canister when the canister is relatively empty (for example less than half full, or less than a quarter full). As such, it may be sufficient in some cases to provide the array of temperature sensors only near the bottom of the canister—for example extending from a position at or near the bottom of the canister to a position a predetermined distance (e.g. one quarter or one half) from the bottom of the canister towards the top of the canister. The first position may be at or near an expected surface of the liquefied gas in the canister when the canister is substantially empty, and the second position may be at or near an expected surface of the liquefied gas in the canister when the canister is substantially full. In particular, it will be appreciated that the canister may not always be used in its upright position (e.g. with the valve on the top, or stood on its base)—it may be used on its side, or inclined at an angle. Accordingly, it may be necessary to provide the strip along the body of the canister in a direction which is not parallel to the base to top axis of the canister. In other words, the direction in which the array of temperature sensors extends should preferably be substantially vertical (upright) in absolute (gravitational) terms. It will of course be understood that the invention will still work even if the direction in which of the temperature sensors extends is not vertical—provided that there is a vertical component. The vertical component ensures that different ones of the temperature sensors are near to the surface of the liquefied gas in the canister when the level of liquefied gas in the canister differs. The detection circuitry may be operable to determine an average of the output values of the array of temperature sensors, and to identify a current level of the liquefied gas in the canister based on the position within the array of a subset of the temperature sensors detected as having output values which deviate from the determined average by greater than a threshold amount. The measurement device may comprise a backing strip upon which the array of temperature sensors is disposed. The backing strip may be flexible, and/or magnetic.

Due to the fact that the temperature sensors detect a temperature drop which occurs as a result of the release of gas from the canister, there is no need to utilise heating elements to heat up the surface of the canister, which would be required before measuring the temperature of the surface of the canister if a temperature difference were to be observed when the canister is not in use, and has not been used for some time. It will be appreciated that this reduces the cost of the system, because heating elements can be omitted, and also removes the safety problems associated with generating heat in the proximity of a gas supply.

The detection circuitry may monitor the outputs of the temperature sensors on a periodic basis, the interval of which is dependent on whether the detection circuitry has recently detected that a subset of the temperature sensors is measuring a lower temperature than the remainder of the temperature sensors. This reduces overall power consumption by reducing the power consumption when the gas canister is not currently in use. The detection circuitry may periodically monitor the outputs of the temperature sensors at a first, fixed, interval when the detection circuitry is detecting that a subset of the temperature sensors is measuring a lower temperature than the remainder of the temperature sensors, and when the detection circuitry determines that the subset of the temperature sensors is no longer measuring a lower temperature than the remainder of the temperature sensors, the detection circuitry may transition to monitoring the outputs of the temperature sensors at a second, progressively increasing, interval. The second, progressively increasing, interval may reach a maximum interval length after the subset of temperature sensors has not measured a lower temperature than the remainder of the temperature sensors for a predetermined period of time. The detection circuitry may be responsive to detecting that a subset of the temperature sensors are measuring a lower temperature than the remainder of the temperature sensors to generate a notification that the canister is currently in use. This function can be provided since a temperature drop at the liquid/gas interface within the canister will only occur while the gas canister is in use, and shortly afterwards (until the system returns to thermal equilibrium). The detection circuitry may be operable determine a rate of gas consumption from the identified level of liquefied gas within the canister measured at a plurality of different times. This results in a gas consumption rate which becomes progressively more accurate as the liquid gas level moves past several temperature sensors over a period of time. The detection circuitry may be operable to estimate a usage time remaining for the canister based on the determined rate of gas consumption. In some embodiments, the detection circuitry may be operable to determine a current rate of gas consumption from the magnitude of the temperature drop measured from the subset of the temperature sensors and the remaining temperature sensors. This provides a very fast indication of gas consumption, but may be relatively unreliable and inaccurate. However, if the determined current rate of gas consumption exceeds a predetermined threshold, the detection circuitry may generate an alert notification. This could be the case where the gas consumption is determined to exceed safe levels, or at least to be at risk of being at an unsafe level based on the temperature drop measured. Further, if the determined current rate of gas consumption exceeds a predetermined threshold, the detection circuitry may control a valve on the canister to stop releasing gas. This could be used to provide an automatic shut off of a gas canister in the event that a risk of unsafe gas consumption rates is detected. Also, as the device uses temperature sensors, if the bottle is determined to become too hot, or the monitoring device itself malfunctions and becomes hot, the device can shut down in response, warn the user and shut off any valves. In some embodiments, it could also communicate with a smartphone app or the like.

According to another aspect of the present invention, there is provided a measurement system comprising a measurement device as described above, and a display device, wherein the measurement device is operable to provide the identified level of liquefied gas to the display device, and the display device is operable to display the received identified level of liquefied gas. In one embodiment the measurement device is electrically connected to the display device, and the identified level of liquefied gas is provided via the electrical connection. In other words, a single integral unit may be provided which both determines gas level (and optionally consumption), and also displays it. In another embodiment, the measurement device is wirelessly connected to the display device, and the identified level of liquefied gas is provided via the wireless connection. In other words, a separate display (user interface) device may be provided, potentially at a position remote from the canister. For example, the display device may be fitted inside a caravan, while the gas canister may be external to the caravan. The display device may also be a smartphone, or other personal device, instead of a dedicated stand-alone unit. The measurement device may be operable to transmit the identified level of liquefied gas to the display device via the wireless connection only when the measurement device is currently detecting that the subset of temperature sensors are measuring a lower temperature than the remainder of the temperature sensors. This reduces power consumption at the measurement device by only transmitting to the display device when there is new, useful, information. The wireless connection may be unidirectional from the measurement device to the display device. This permits a reduction in the complexity of the system, resulting in cost savings. The display device may be operable to display one or both of a current level of the liquefied gas in the canister, and a usage time remaining based on current and/or past usage. The display device may be responsive to the non-receipt of a communication from the measurement device for a predetermined period of time to display a message notifying the user. The user is then able to check the battery on the measurement device. While embodiments of the present invention are advantageous in that they can be retrofitted to existing canisters, the measurement device may instead be integrated into the body of a canister. A canister comprising the measurement device as described above is therefore envisaged as a further aspect of the present invention.

In order to provide improved accuracy and reliability, the detection circuitry may be operable to calculate a line of best fit from the temperature measurements taken by the array of temperature sensors, and to identify the current fill level from the line of best fit. The line of best fit may be a cubic line of best fit generated by multiplying the temperature measurements taken by the array of temperature sensors with a predetermined matrix to obtain a set of coefficients for the cubic line of best fit. The detection circuitry may be operable to compare a gradient of the line of best fit with a predetermined threshold to identify one or both of (a) whether the canister is in use, and (b) whether a valid fill level can be taken from the line of best fit.

Viewed from another aspect, there is provided a method of monitoring the level of liquefied gas in a canister, the method comprising: mounting an array of temperature sensors externally of the canister to extend from a first position on the canister to a second position on the canister; detecting when a subset of the temperature sensors is measuring a lower temperature than the remainder of the temperature sensors; and identifying a current level of the liquefied gas in the canister based on the position within the array of the subset of the temperature sensors detected as measuring a lower temperature.

Further aspects of the present invention include a computer program, and a computer readable medium.

### DETAILED DESCRIPTION

Embodiments of the present invention will now be described with reference to the following drawings, in which:

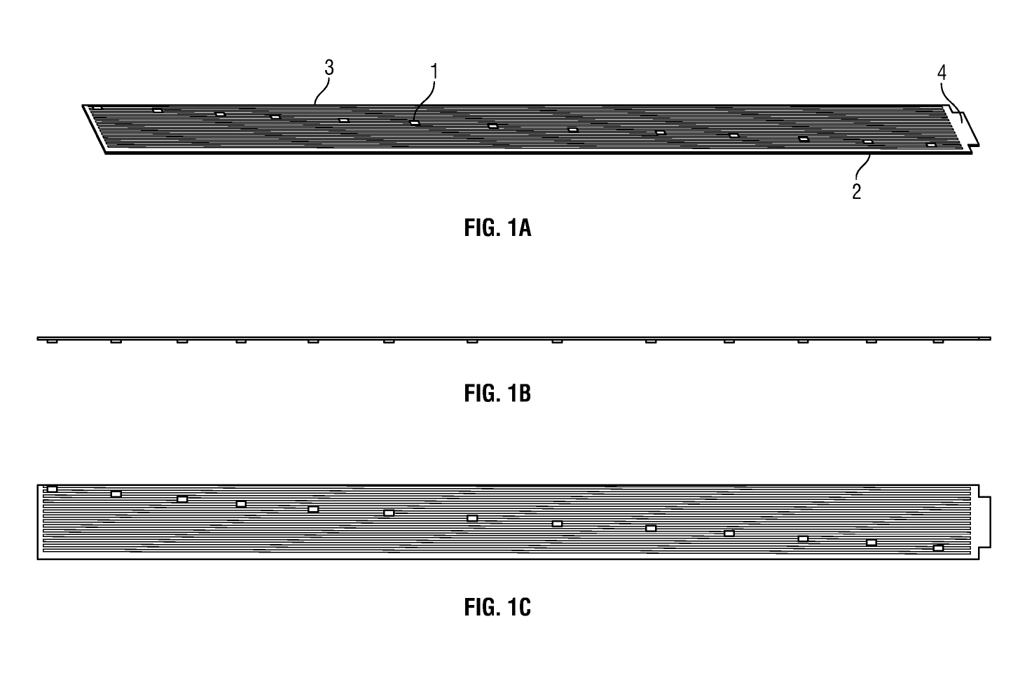

FIGS. 1A to 1C schematically illustrate a flexible thermistor strip according to an embodiment of the present invention;

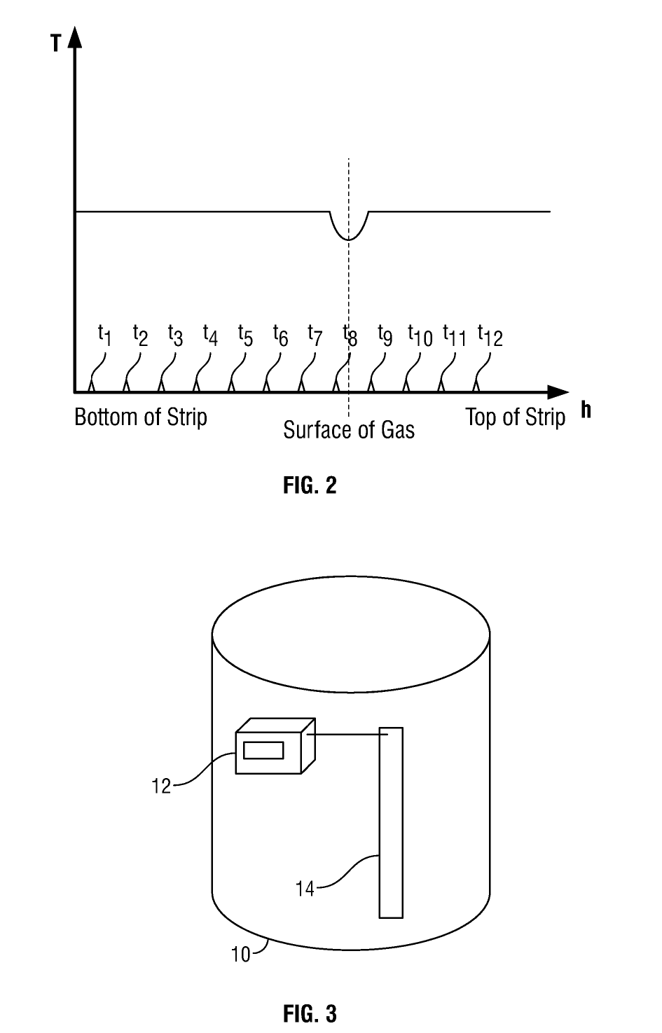

FIG. 2 schematically illustrates a temperature profile of a gas canister currently in use;

FIG. 3 schematically illustrates a measurement system according to a first embodiment of the present invention;

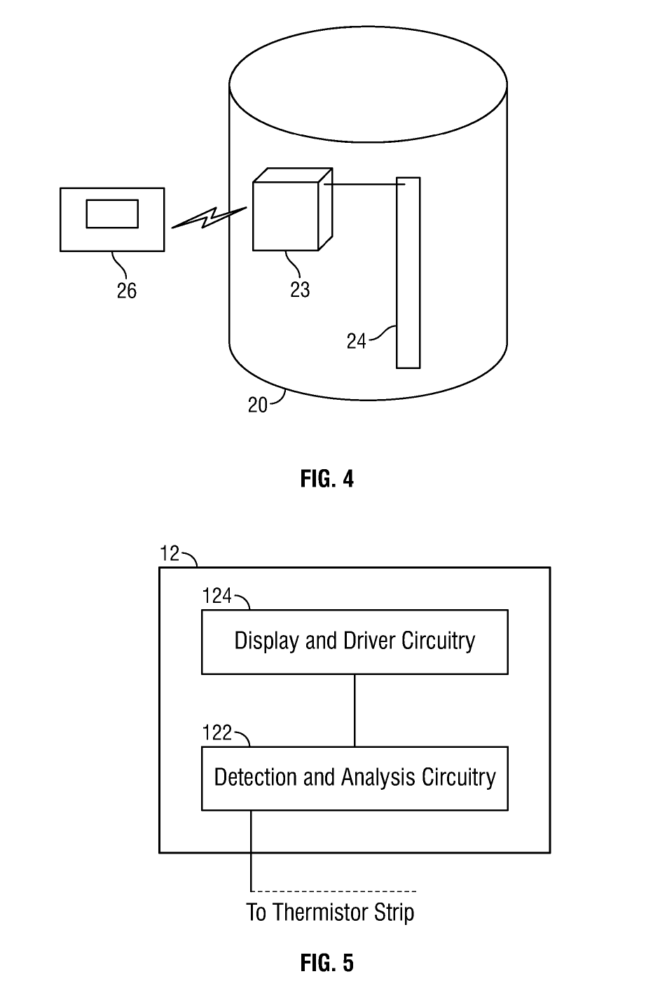

FIG. 4 schematically illustrates a measurement system according to a second embodiment of the present invention;

FIG. 5 schematically illustrates the measurement system of FIG. 3 in more detail;

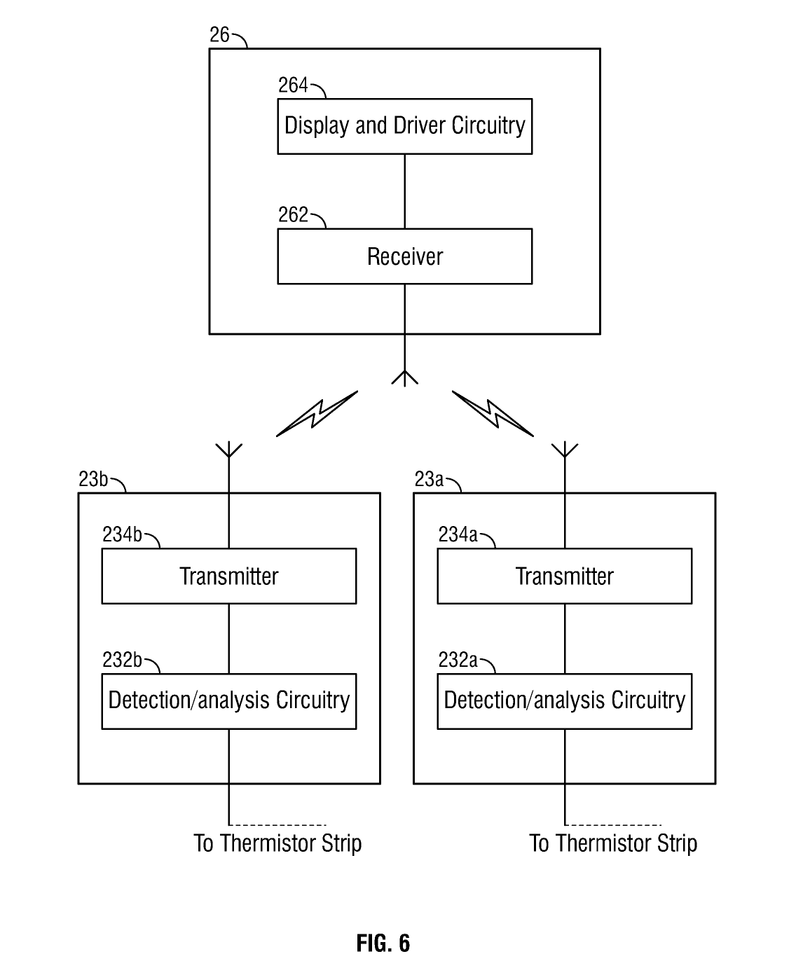

FIG. 6 schematically illustrates the measurement system of FIG. 4 in more detail;

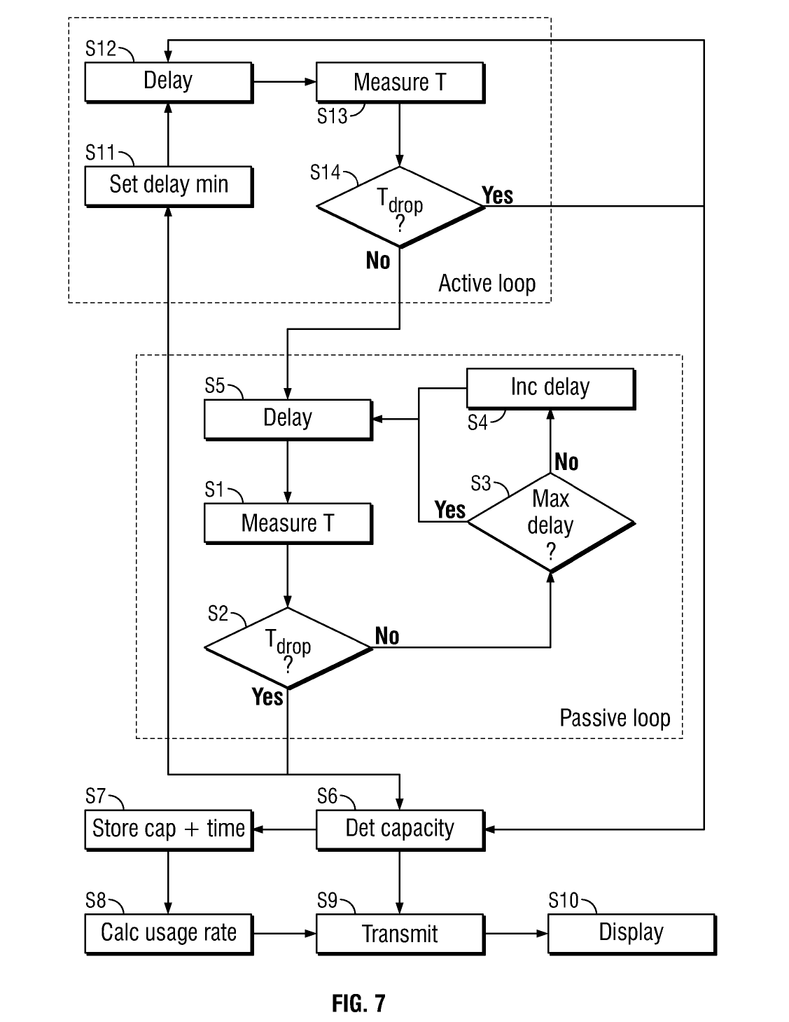

FIG. 7 is a schematic flow diagram illustrating the operation of the measurement system; and

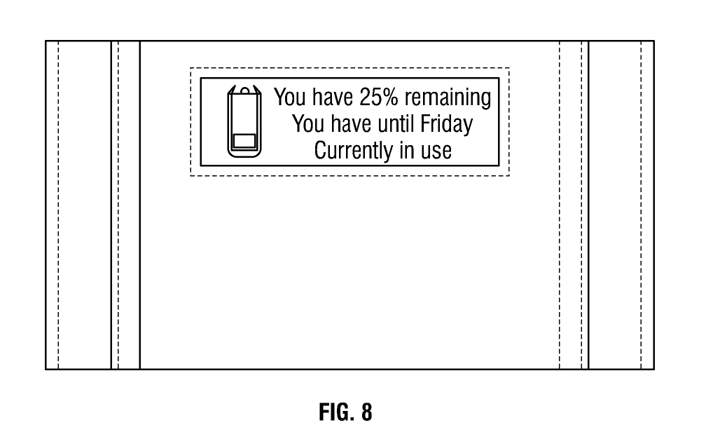

FIG. 8 schematically illustrates a User Interface display.

### DESCRIPTION OF THE EXAMPLE EMBODIMENTS

Referring first to FIG. 1A, a flexible thermistor strip is schematically illustrated in oblique view. The flexible thermistor strip comprises an array of thermistors 1 disposed at spatially separated positions along the length of a backing strip of a polyamide film 2. The thermistors 1 are electrically connected via copper tracks 3 to an edge connector 4. The edge connector 4 can be connected to circuitry (not shown in FIG. 1) which is able to process the electrical outputs of the respective thermistors. Each thermistor 1 outputs, via its respective copper track 3 and the edge connector 4, a voltage representative of the current temperature at the thermistor in the normal way. Referring next to FIG. 1B, a side view of the flexible thermistor strip is shown, in which the thermistors 1 project slightly above the generally flat structure of the strip. Referring to FIG. 1C, a top plan view of the flexible thermistors strip is shown. FIG. 1 therefore shows a flexible circuit board made of chemically etched copper clad polyamide, with a daisy chain of thermistors along the edge of the sensing strip. In use, the flexible thermistor strip is affixed to the exterior of a liquefied gas canister, typically from its base (empty level) to near its top (full level), although more generally the strip can be affixed to the canister by the user to extend from an empty level of the canister to (or at least towards) a full level of the canister. The daisy chain of thermistors makes it possible to identify the leading edge of a temperature gradient along the flexible thermistor strip.

Referring to FIG. 2, a temperature gradient (profile) of a gas canister currently in use is shown on a graph. The x-axis of the graph (h) represents the distance from the bottom of the strip (left hand side) to the top of the strip (right hand side). The positions of thermistors t₁ to t₁₂ are shown along the bottom of the x-axis. The y-axis (T) represents the temperature along the strip, which is sampled at intervals (represented by the small triangles adjacent to the x-axis) by the thermistors disposed along the strip. When the gas canister is in use (gas is being released from the canister via a valve), the pressure of the gas head in the canister reduces. The faster gas is released from the canister, the faster the pressure drops. The reduction in pressure causes some of the liquefied gas to evaporate into its gaseous form. This causes a temperature drop at the liquid/gas interface, which lowers the temperature of a ring shaped portion of the body of the canister adjacent to the liquid/gas interface. The magnitude of the temperature drop is dependent on the rate of gas consumption. As a result, one or more thermistors which are proximate the liquid/gas interface will measure a lower temperature than the thermistors further away from the liquid/gas interface. Accordingly, if the bottom of the flexible thermistor strip is affixed at or near an empty level of the canister and the top of the strip is affixed at or near a full level of the canister, then the distance along the strip to the thermistor(s) measuring a lower temperature than the remaining thermistors provides an indication of the amount of liquefied gas remaining in the canister. In FIG. 2, it can be seen that there is a temperature drop around thermistor t₈, which will therefore give a lower temperature measurement than the remaining thermistors. The thermistor t₈ is just over half way from the bottom to the top of the strip, which enables a determination that the canister is just over half full. It will be appreciated that, when the canister is not currently in use, and has not been in use for some time, the liquid/gas interface will revert back to an equilibrium temperature, and the thermistor strip will no longer be able to detect the position of the liquid/gas interface. The magnitude of the temperature drop is also dependent on the duration of current use—i.e. how long gas has been continuously escaping from the bottle, meaning that the temperature drop may “build up” over time, and only be at a detectable magnitude after a few seconds, or even many minutes, of gas use.

Referring now to FIG. 3, a measurement system according to a first embodiment of the present invention is schematically illustrated. The measurement system comprises a combined detection/analysis device and display device 12, which is affixed (for example magnetically) to a liquefied gas canister 10. Also affixed (again magnetically, for example) to the canister 10 is a flexible thermistor strip 14, as described in FIG. 1. The flexible thermistor strip 14 is electrically connected to the combined detection/analysis device and display device 12, for example using the edge connector 4. The combined detection/analysis device and display device 12 receives the outputs from the thermistor strip 14, determines an average of the output values of the array of thermistors, and compares each of the output values with that average, to identify any output values which are less than the average by an amount greater than or equal to a predetermined threshold. A current level of the liquefied gas in the canister is then determined based on the position within the array of the thermistors detected as having output values which deviate from the determined average by greater than the threshold amount. The determined current level of liquefied gas is then displayed by the combined detection/analysis and display device 12. The combined detection/analysis and display device 12 may also conduct further analysis to determine a current rate of consumption and estimated usage time remaining, which may also be displayed. A current rate of gas consumption may also be estimated from the magnitude of the temperature drop measured from the subset of the temperature sensors and the remaining temperature sensors. While this method is unlikely to be accurate enough to predict usage time remaining, it provides a relatively quick indication of a high rate of gas consumption. As a result, if the determined current rate of gas consumption exceeds a predetermined threshold, an alert notification may be made, and/or a valve on the canister may be controlled to stop releasing gas.

Referring now to FIG. 4, a measurement system according to a second embodiment of the present invention is schematically illustrated. The measurement system comprises a detection/analysis device 23 which is affixed (for example magnetically) to a liquefied gas canister 20. Also affixed (again magnetically, for example) to the canister 20 is a flexible transistor strip 24, as described in FIG. 1. The flexible thermistor strip 24 is electrically connected to the detection/analysis device 23, for example using the edge connector 4. The detection/analysis device 23 receives the outputs from the thermistor strip 14, determines an average of the output values of the array of thermistors, and compares each of the output values with that average, to identify any output values which are less than the average by an amount greater than or equal to a predetermined threshold. A current level of the liquefied gas in the canister is then determined based on the position within the array of the thermistors detected as having output values which deviate from the determined average by greater than the threshold amount. The determined current level of liquefied gas is then transmitted wirelessly to a display device 26 via a unidirectional radio link. As a result, the display device 26 may be provided at a location convenient for the user of the system. The current level of liquefied gas received at the display device 26 is then displayed. The detection/analysis device 23 may also conduct further analysis to determine a current rate of consumption and estimated usage time remaining, which may also be transmitted to the display device 26, and displayed to the user.

In either embodiment, the thermistor strip could be provided integrally with the canister—i.e. as part of the canister wall. Similarly, other on-bottle components (the entire system for the FIG. 3 embodiment, or the detection/analysis device in the FIG. 4 embodiment) could be provided integrally with the canister.

Referring to FIG. 5 the measurement system of FIG. 3 is schematically illustrated in more detail. In particular, the combined detection/analysis and display device 12 is shown to include detection and analysis circuitry 122 which is connected to and monitors the outputs of the thermistor strip, and a display (e.g. LCD) and driver circuitry 124 which displays the current gas level and estimate usage time remaining. Referring now to FIG. 8, an example display is shown. It can be seen that the display shows a graphical indication of the current volume of gas in the container, and also a text explanation of the same. The display also indicates that, based on current and past usage patterns the gas remaining will last until Friday. Finally, the display indicates that the gas canister is currently in use. The latter item of information can be derived by the detection and analysis circuitry 122 from the fact that the detection and analysis circuitry 122 is able to detect a temperature drop—since this will only be possible if gas is currently leaving the container, or has recently left the container.

Referring now to FIG. 6, the measurement system of FIG. 4 is schematically illustrated in more detail. In addition, FIG. 6 demonstrates that the measurements from multiple measurement devices can be transmitted to a single display device. In this way, a user with multiple canisters can monitor the current liquefied gas level in all of these using the same user interface (display) device. In FIG. 6, a detection/analysis device 23a, and a detection/analysis device 23b are shown, each of which may be affixed to a different liquefied gas container. The detection/analysis device 23a comprises detection/analysis circuitry 232a, which is connected to and monitors the outputs of the thermistor strip, and a transmitter 234a, which is able to transmit the measurements and analysis outputs to a separate display device 26. The display device 26 comprises a receiver 262 for wirelessly receiving the measurements and analysis outputs from the transmitter 234a of the detection/analysis device 23a, and also from a transmitter 234b of the detection/analysis device 232b. It will be appreciated that, like the device 23a, the device 23b comprises detection/analysis circuitry 232b connected to a thermistor strip. The display device 26 also comprises a display (e.g. LCD) and driver circuitry 264 which displays the current gas level and estimate usage time remaining in relation to each of the detection/analysis devices 23a and 23b, as received via the receiver 262.

Referring now to FIG. 7, a schematic flow diagram illustrating the operation of the measurement system is provided. As can be seen from FIG. 7, the operation comprises an active loop (which applies while a temperature drop is currently being detected) and a passive loop (which applied while no temperature drop is currently being detected). In the passive loop, at a step S1 the temperature at each thermistor is measured, and at a step S2 it is determined whether one or more of the thermistors is measuring a temperature drop (from the average of all thermistor measurements) exceeding a predetermined magnitude. If not, then it is not possible to determine the current level of liquefied gas in the container. In this case, at a step S3 it is determined whether a currently set delay before measuring the temperature at the thermistors again is at a maximum level. If the currently set delay is not at the maximum level, then the currently set delay is increased at a step S4, and then the resulting delay is applied at a step S5, before the step S1 is repeated. If the currently set delay is already at the maximum level then it is not increased, but instead the currently set delay is applied at the step S5, before the step S1 is increased. If however at the step S2 a temperature drop is detected, then at a step S6 the current capacity of liquefied gas in the container is determined based on the position within the linear array of the thermistors exhibiting a temperature drop with respect to the other thermistors within the array. At a step S7, the determined capacity and current time are stored to assist with the generation of a past usage profile. If at least one previous measurement has been stored at a previous iteration of the step S7, then at a step S8 a usage rate and resulting time remaining is calculated based on the data stored at the step S7. Then, at a step S9 the determined capacity and usage rate/time remaining are transmitted to the display device at a step S9. At a step S10, the display device displays the receiving capacity and usage rate/time information. In addition to the steps S6 to S10, an affirmative finding at the step S2 results in the process entering the active loop at a step S11. In particular, the step S11 sets the currently set delay to a minimum value, which is then applied at a step S12. Then, at a step S13 the temperature at each thermistor is measured, and at a step S14 it is determined whether one or more of the thermistors is measuring a temperature drop (from the average of all thermistor measurements) exceeding a predetermined magnitude. If not, then it is not possible to determine the current level of liquefied gas in the container. In this case, the process re-enters the passive loop, and the delay step S5 is conducted. If however at the step S14 a temperature drop is detected, then the steps S6 to S11 are conducted in the manner described above, and in addition the process moves to the delay step S12 where the currently set (minimum) delay is applied before another temperature reading is taken. In this way, measurements are taken more regularly when a temperature drop is currently being detected (active loop), and shortly thereafter (the early stages of the passive loop—before the delay has increased significantly), than when no temperature drop has been detected for some time. Referring back to the steps S6, S7 and S8, the process of generating a prediction of usage time remaining can be conducted as follows. The device takes its first reading, which might for example be that the current liquefied gas level is at or around the position of the thermistor t₁₁ indicated in FIG. 2 (that is, near the top of the strip), and then starts a counter, or otherwise logs the time of the reading. Subsequently, when the “cold” area then touches the next temperature sensor down t₁₀, the time is again logged. It is assumed that the time this has taken is 1/12 of the time it will take to use the whole bottle (there are 12 temperature sensors up the length of the bottle in the FIG. 2 example). This is extrapolated into a reading in days or weeks of the usage time remaining before all the gas in the container has been used. This is then stored, and when the cold area reaches the next temperature sensor, another time is taken, and is then added to the first time and divided by 2 to take an average, so the more the bottle is used, the more accurate the averaged time becomes.

In some circumstances, the log, or certain measurements recorded in the log, may be refreshed. One example of this may be if the canister has not been used in some time, creating an artificially long time delay between measurements. This “refresh” operation could be triggered after the passive loop has been continuously operating for greater than a predetermined period of time. The prediction algorithm may then start again based entirely on new measurements. Alternatively, the previous measurements may be refreshed, but the most recently calculated usage rate may be carried forward into the new period of usage, to be modified based on new measurements as they become available. It will also be understood that the prediction algorithm may be initiated with an assumed usage rate (for example the first time the system has been used), which is replaced with an actual usage rate once two or more real measurements have been taken. It will be appreciated from FIG. 7 that data is transmitted to the display device only when a temperature drop has been detected. As a result, it is possible that no transmissions may take place for some time, if the canister is left unused. However, transmissions may also stop if the measurement device runs out of power (the device is most likely to be battery powered) or develops a fault. Accordingly, the display device may generate an alert if no transmission has been received for some time. This prompts the user to make a judgement as to whether this is simply because the canister has not been used for a long while, or alternatively to check the battery and operation of the measurement device.

By way of summary, embodiments of the invention provide a gas sense device which monitors the level of gas in a gas container on a constant or periodic basis. This is achieved with a strip of thermistors, which detect the surface of a liquefied gas, to determine the volume of liquefied gas remaining in the container.

The determined volume is wirelessly transmitted to a user interface (display device), across a radio link. Usage is monitored, and a user's past use profile is used to predict how much longer the usage of the current canister will last. This information is displayed on the display device as a proportion of the gas bottle which is currently full, and an estimated time remaining. The sensing unit may be a flexible magnetically backed strip, covered in neoprene, with a circuitry box on the bottom of it. The user interface unit may have a receiver and a graphical LCD to display the information. While in the above description, all temperature drop detection and usage analysis is conducted by the unit affixed to the canister, it would be possible to instead conduct one or both of these functions at the display device, leaving the canister mounted component to for example merely collect thermistor readings and periodically (or on request if a bidirectional radio link is used) transmit these to a display device, where temperature drops are detected and usage rates and times remaining calculated and predicted. It will also be appreciated that the display device as described above need not be a dedicated device, but could be a general purpose computer, tablet computer, or smartphone.

Embodiments of the present invention could also be used to control the switching of gas supplies. In other words, when the measurement device determines that the current gas level is too depleted, it could trigger a computer controlled valve to switch the supply of gas from the depleted bottle to a different gas canister.

In some cases, it may be difficult to clearly identify a single lowest temperature value from the measured values. This may be due to tolerances in the components and/or marginal differences in temperature at the temperature sensors. In one embodiment, this difficulty is alleviated by plotting a polynomial line of best fit for the measured temperature values, and finding the minimum value of this line. The minimum value of the line of best fit represents a minimum temperature value and thus, the position of the surface of the liquid can be found more reliably. The properties (shape) of this line of best fit can determine whether the bottle is in use. For example, the greater the rate at which gas is being released from the canister, the larger the temperature drop at the gas/liquid interface will be. This can be expected to translate into a steeper gradient for the line of best fit. It therefore follows that if the gradient of the line of best fit is less than a predetermined threshold then it can be assumed that the canister is not in use (and has not recently been in use), and that a valid reading can therefore not be taken. An “in use/not in use” indication could be displayed in dependence on this. There may be an absolute value of gradient, which the sensors are no longer accurate below, which acts as a cut off. So if there is a very tiny discharge from the canister, no reading will be recorded, as it cannot be relied on that the ambient conditions are not rendering the measurements unreliable.

In principle, the gradient of the line of best fit could also be used as an indicator of the rate of gas release from the canister (and thus used in predicting gas time remaining, and current consumption rate). It will be appreciated that when the bottle ceases to be in use (gradient drops below the predetermined threshold, the last known fill level is stored and displayed until valid results are again detected (that is, when the gradient again exceeds the predetermined threshold). An explanation of the line of best fit calculation and an example derivation for a suitable regression matrix for a five sensor monitor is set out below.

### Regression Matrix Derivation (for an Array of 5 Temperature Sensors)

$$X := \begin{matrix}{1}^{0} & {1}^{1} & {1}^{2} & {1}^{3} \\ {2}^{0} & {2}^{1} & {2}^{2} & {2}^{3} \\ {3}^{0} & {3}^{1} & {3}^{2} & {3}^{3} \\ {4}^{0} & {4}^{1} & {4}^{2} & {4}^{3} \\ {5}^{0} & {5}^{1} & {5}^{2} & {5}^{3}\end{matrix} = \begin{matrix}1 & 1 & 1 & 1 \\ 1 & 2 & 4 & 8 \\ 1 & 3 & 9 & 27 \\ 1 & 4 & 16 & 64 \\ 1 & 5 & 25 & 125\end{matrix}$$

$${X}^{T} = \begin{matrix}1 & 1 & 1 & 1 & 1 \\ 1 & 2 & 3 & 4 & 5 \\ 1 & 4 & 9 & 16 & 25 \\ 1 & 8 & 27 & 64 & 125\end{matrix}$$

X^{T} is a reflection of 45°.

By multiplying the matrix transpose with its original self, a square matrix is formed, which is represented by X₁.

$${X}_{1} = {X}^{T} \cdot X = \begin{matrix}5 & 15 & 55 & 225 \\ 15 & 55 & 225 & 979 \\ 55 & 225 & 979 & 4.425 \cdot {10}^{3} \\ 225 & 979 & 4.425 \cdot {10}^{3} & 2.052 \cdot {10}^{4}\end{matrix}$$

This square matrix is then multiplied by the original transpose matrix, to provide the final regression matrix, which multiplies with the readings from the bottle, to provide the cubic coefficients of best fit.

$${X}_{1}^{- 1} \cdot {X}^{T} = \begin{matrix}3.2 & - 2.8 & - 0.8 & 2.2 & - 0.8 \\ - 3.024 & 4.262 & 0.857 & - 3.405 & 1.31 \\ 0.893 & - 1.571 & - 0.143 & 1.149 & - 0.607 \\ - 0.083 & 0.167 & 2.442 \cdot {10}^{- 15} & - 0.167 & 0.083\end{matrix}$$

The values can then be truncated to form the matrix, M.

$$M := \begin{matrix}3.2 & - 2.8 & - 0.8 & 2.2 & - 0.8 \\ - 3.0 & 4.3 & 0.9 & - 3.4 & 1.3 \\ 0.9 & - 1.6 & - 0.1 & 1.4 & - 0.6 \\ - 0.1 & 0.2 & 0.0 & - 0.2 & 0.1\end{matrix}$$

The matrix M provides a matrix of constants, dictated by the above derivation. Matrix M is then multiplied with the five readings taken from the array of temperature sensors, to give an output of 4 numbers, which correspond to the coefficients of the cubic line of best fit.

Readings:=38, 37, 35, 34, 35

This is a series of 5 readings taken from the gas bottle, via the microcontrollers ADC (analogue to digital converter) channels. These variables which may change every time a reading is taken.

$$Coefficients := M \cdot Readings = \begin{matrix}A \\ B \\ C \\ D\end{matrix} = \begin{matrix}36.8 \\ 6.5 \\ - 1.9 \\ 0.3\end{matrix}$$

Therefore, y=36.8x³+6.5x²−1.9x+0.3 is the cubic line of best fit, to the points defined above. The x axis represents a value indicative of temperature, while the y axis represents a position along the array of temperature sensors (and thus the height of the canister).

The Coefficients must be differentiated, to find the turning points for the curve (so we can find the minimum) hence:

$$y = {Ax}^{3} + {Bx}^{2} + Cx + D goes to y = 3 {Ax}^{2} + 2 Bx + C$$

$$y 1 = \frac{( - {B}_{D} + \sqrt{{B}_{D}^{2} - 4 \cdot {A}_{D} \cdot {C}_{D}}}{2 \cdot {A}_{D}}$$

$$y 2 = \frac{( - {B}_{D} - \sqrt{{B}_{D}^{2} - 4 \cdot {A}_{D} \cdot {C}_{D}}}{2 \cdot {A}_{D}}$$

The Quadratic formula can be used to solve the differentiated quadratic, so find the two x-intercepts, which correspond to the cubic turning points, giving the coldest and hottest points of the bottle.

y1=0.085y2=−0.203

The Coldest point is clearly at y1, as the other point is beyond the bottom of the gas bottle, which whilst the bottle is in use is an impossible reading.

This value of y1 can then be converted to a fill percentage, for example in the present case by multiplying it by the number of sensors (5) and dividing it by 100.

Thus: y1=0.085/5*100=1.7% full

1. A measurement device for monitoring the level of liquefied gas in a canister, the device comprising:
an array of at least three temperature sensors, configured to be mounted externally of the canister to extend from a first position on the canister to a second position on the canister; and
detection circuitry for detecting, when gas is released from the canister causing a temperature drop at the liquid-gas interface within the canister, a subset of the at least three temperature sensors which measure a lower temperature than the remainder of the at least three temperature sensors, and for identifying a current level of the liquefied gas in the canister based on the position within the array of the subset of the at least three temperature sensors detected as measuring the lower temperature.

2. The measurement device according to claim 1, wherein the first position is at or near the bottom of the canister, and the second position is at or near the top of the canister.

3. The measurement device according to claim 1, wherein the first position is at or near an expected surface of the liquefied gas in the canister when the canister is substantially empty, and the second position is at or near an expected surface of the liquefied gas in the canister when the canister is substantially full.

4. The measurement device according to claim 1, wherein the detection circuitry is operable to determine an average of the output values of the array of at least three temperature sensors; and to identify a current level of the liquefied gas in the canister based on the position within the array of a subset of the at least three temperature sensors detected as having output values which deviate from the determined average by greater than a threshold amount.

5. The measurement device according to claim 1, further comprising a backing strip upon which the array of temperature sensors is disposed.

6. The measurement device according to claim 5, wherein the backing strip is flexible.

7. The measurement device according to claim 5, wherein the backing strip is magnetic.

8. The measurement device according to claim 1, wherein the detection circuitry monitors the outputs of the at least three temperature sensors on a periodic basis, the interval of which is dependent on whether the detection circuitry has recently detected that a subset of the at least three temperature sensors is measuring a lower temperature than the remainder of the at least three temperature sensors.

9. The measurement device according to claim 8, wherein the detection circuitry periodically monitors the outputs of the at least three temperature sensors at a first, fixed, interval when the detection circuitry is detecting that a subset of the at least three temperature sensors is measuring a lower temperature than the remainder of the at least three temperature sensors, and when the detection circuitry determines that the subset of the at least three temperature sensors is no longer measuring a lower temperature than the remainder of the at least three temperature sensors, the detection circuitry transitions to monitoring the outputs of the at least three temperature sensors at a second, progressively increasing, interval.

10. The measurement device according to claim 9, wherein the second, progressively increasing, interval reaches a maximum interval length after the subset of at least three temperature sensors has not measured a lower temperature than the remainder of the at least three temperature sensors for a predetermined period of time.

11. The measurement device according to claim 1, wherein the detection circuitry is responsive to detecting that a subset of the at least three temperature sensors are measuring a lower temperature than the remainder of the at least three temperature sensors to generate a notification that the canister is currently in use.

12. The measurement device according to claim 1, wherein the detection circuitry is operable determine a rate of gas consumption from the identified level of liquefied gas within the canister measured at a plurality of different times.

13. The measurement device according to claim 12, wherein the detection circuitry is operable to estimate a usage time remaining for the canister based on the determined rate of gas consumption.

14. The measurement device according to claim 1, wherein the detection circuitry is operable to determine a current rate of gas consumption from the magnitude of the temperature drop measured from the subset of the at least three temperature sensors and the remaining at least three temperature sensors.

15. The measurement device according to claim 14, wherein if the determined current rate of gas consumption exceeds a predetermined threshold, the detection circuitry generates an alert notification.

16. The measurement device according to claim 14, wherein if the determined current rate of gas consumption exceeds a predetermined threshold, the detection circuitry controls a valve on the canister to stop releasing gas.

17. A measurement system comprising:
a measurement device comprising:
an array of at least three temperature sensors, configured to be mounted externally of the canister to extend from a first position on the canister to a second position on the canister; and
detection circuitry for detecting, when gas is released from the canister causing a temperature drop at the liquid-gas interface within the canister, a subset of the at least three temperature sensors which measure a lower temperature than the remainder of the at least three temperature sensors, and for identifying a current level of the liquefied gas in the canister based on the position within the array of the subset of the at least three temperature sensors detected as measuring the lower temperature; and
a display device, wherein the measurement device is operable to provide the identified level of liquefied gas to the display device, and the display device is operable to display the received identified level of liquefied gas.

18. The measurement system according to claim 17, wherein the measurement device is electrically connected to the display device, and the identified level of liquefied gas is provided via the electrical connection.

19. The measurement system according to claim 17, wherein the measurement device is wirelessly connected to the display device, and the identified level of liquefied gas is provided via the wireless connection.

20. The measurement system according to claim 19, wherein the measurement device is operable to transmit the identified level of liquefied gas to the display device via the wireless connection only when the measurement device is currently detecting that the subset of the at least three temperature sensors are measuring a lower temperature than the remainder of the at least three temperature sensors.

21. The measurement system according to claim 19, wherein the wireless connection is unidirectional from the measurement device to the display device.

22. The measurement system according to claim 16, wherein the display device is operable to display one or both of a current level of the liquefied gas in the canister, and a usage time remaining based on current and/or past usage.

23. The measurement device system according to claim 16, wherein the display device is responsive to the non-receipt of a communication from the measurement device for a predetermined period of time to display a message notifying the user.

24. The measurement device according to claim 1, wherein the detection circuitry is operable to calculate a line of best fit from the temperature measurements taken by the array of the at least three temperature sensors, and to identify the current fill level from the line of best fit.

25. The measurement device according to claim 24, wherein the line of best fit is a cubic line of best fit generated by multiplying the temperature measurements taken by the array of the at least three temperature sensors with a predetermined matrix to obtain a set of coefficients for the cubic line of best fit.

26. The measurement device according to claim 24, wherein the detection circuitry is operable to compare a gradient of the line of best fit with a predetermined threshold to identify one or both of (a) whether the canister is in use, and (b) whether a valid fill level can be taken from the line of best fit.

27. A canister comprising:
a measurement device comprising:
an array of at least three temperature sensors, configured to be mounted externally of the canister to extend from a first position on the canister to a second position on the canister; and
detection circuitry for detecting, when gas is released from the canister causing a temperature drop at the liquid-gas interface within the canister, a subset of the at least three temperature sensors which measure a lower temperature than the remainder of the at least three temperature sensors, and for identifying a current level of the liquefied gas in the canister based on the position within the array of the subset of the at least three temperature sensors detected as measuring the lower temperature, the measurement device being integrated into the body of the canister.

28. A method of monitoring the level of liquefied gas in a canister, the method comprising:
mounting an array of at least three temperature sensors externally of the canister to extend from a first position on the canister to a second position on the canister;
detecting, when gas is released from the canister causing a temperature drop at the liquid-gas interface within the canister, a subset of the at least three temperature sensors measuring a lower temperature than the remainder of the at least three temperature sensors; and
identifying a current level of the liquefied gas in the canister based on the position within the array of the subset of the at least three temperature sensors detected as measuring the lower temperature.

29. A non-transitory computer readable medium comprising instructions that, when executed, cause at least one processor to:
detect, when gas is released from a canister on which an array of at least three temperature sensors are externally mounted, causing a temperature drop at the liquid-gas interface within the canister, a subset of the at least three temperature sensors measuring a lower temperature than the remainder of the at least three temperature sensors; and
identifying a current level of the liquefied gas in the canister based on the position within the array of the subset of the at least temperature sensors detected as measuring the lower temperature.
